(19) United States
(12) Patent Application Publication
(10) Pub. No.: US 2018/0181187 A1
(43) Pub. Date: Jun. 28, 2018

(54) METHOD FOR DYNAMICALLY UPDATING FINANCIAL DATA AND PROCESSING SYSTEM USING THE SAME, AND METHOD FOR DYNAMICALLY ADJUSTING POWER CONFIGURATION AND PROCESSING SYSTEM USING THE SAME

(71) Applicant: CyberSoft Digital Services Corp., Taipei City (TW)

(72) Inventor: CHUN-KANG CHU, Taipei City (TW)

(21) Appl. No.: 15/441,897

(22) Filed: Feb. 24, 2017

(30) Foreign Application Priority Data
Dec. 22, 2016 (CN) 201611196558.7

(51) Int. Cl. G06F 1/32; G06F 17/30; G06Q 40/00

(52) U.S. Cl. CPC G06F 1/3234; G06F 1/3206; G06Q 40/00; G06F 17/30345

(57) ABSTRACT

A method for dynamically updating financial data suitable for updating financial data of identification data includes receiving transaction data of the identification data; temporarily storing the transaction data; executing batch updates of the financial data of the same identification data according to a batch size and the transaction data. The step of executing each batch update includes obtaining a batch of update information from the transaction data according to a current batch size, driving a timer unit to count an updating time, updating a batch of financial data in the financial data corresponding to the batch of update information with the batch of update information, and adjusting the batch size of a next batch update according to the updating time and a time threshold. Therefore, the occurrence frequency of the transaction timeout events can be reduced and the system resources can be utilized efficiently.

### CROSS-REFERENCE TO RELATED APPLICATION

This non-provisional application claims priority under 35 U.S.C. § 119(a) to Patent Application No. 201611196558.7 filed in China, P.R.C. on Dec. 22, 2016, the entire contents of which are hereby incorporated by reference.

### BACKGROUND

### Technical Field

The instant disclosure relates to an information processing technology for financial data, in particular, to a method for dynamically updating financial data and a processing system using the same, and to a method for dynamically adjusting power configuration and a processing system using the same.

### Related Art

Transactions are popular and frequent in the nowadays society. Electrical commerce business models are developed for providing convenient commercial activities. Commonly, the electrical commercial activities are performed on websites. Therefore, the electrical commercial activities would not be limited by time and place. In other words, as long as a consumer can connect with a network, whenever and wherever, the consumer can conduct an on-line transaction.

An on-line transaction processing system (OLTP system) utilizes relational databases to process and/or analyze millions of daily transactions. In order to maintain the uniformity and the completeness of the financial data in the relational database, the OLTP system usually has a data lock mechanism for preventing the confliction between the financial data in different transactions.

However, when the lock time of the financial data is too long or when the number for the locked financial data is too huge, the access of the locked financial data from other transactions (e.g., checking transaction contents) may be temporarily blocked. Once the locked financial data is blocked, a timeout signal is triggered by a front transaction process terminal. For example, when an account tends to conduct an online transaction, the transaction will be denied because the financial data of the account is locked. As a result, the online transaction cannot be conducted.

### SUMMARY

In one embodiment, a processing system for dynamically updating financial data comprises a storage unit, a timer unit, an interface unit, a register unit, and a processing unit. The processing unit is connected to the storage unit, the timer unit, the interface unit, and the register unit. The storage unit stores a plurality of identification data and financial data of the identification data. The timer unit counts an updating time. The interface unit receives transaction data of the identification data. The register unit temporarily stores the transaction data. The processing unit executes batch updates of the financial data of the same identification data according to a batch size and the transaction data. Wherein, in executing each of the batch updates, the processing unit obtains a batch of update information from the transaction data according to a current batch size, drives the timer unit, updates a batch of financial data in the financial data corresponding to the batch of update information with the batch of update information, and adjusts the batch size of a next batch update according to the updating time and a time threshold of a batch of update information.

In one embodiment, a method for dynamically updating financial data is suitable for updating a plurality of financial data of a plurality of identification data. The method comprises receiving a plurality of transaction data of the identification data; temporarily storing the transaction data; executing batch updates of the financial data of the same identification data according to a batch size and the transaction data. Wherein, the step of executing each of the batch updates comprises obtaining a batch of update information from the transaction data according to a current batch size; driving a timer unit to count an updating time; updating a batch of financial data in the financial data corresponding to the batch of update information with the batch of update information; and adjusting the batch size of a next batch update according to the updating time and a time threshold of the batch of update information.

In one embodiment, a processing system for dynamically adjusting power configuration comprises an interface unit, a storage unit, a timer unit, a power unit, a processing unit, and a power supply circuit. The interface unit receives at least one transaction data. The storage unit stores a plurality of financial data. The timer unit counts a response time for each of batch updates. The processing unit executes batch updates of the financial data according to the transaction data. The power supply circuit is controlled by the processing unit and supplies electricity, based on the power unit, for operating the processing unit. Wherein, the processing unit further calculates an average response time of each of unit times in each of a plurality of operation durations according to the response times of all of the batch updates in each of the unit times, and the processing unit configures a power supply mode of the power supply circuit in at least one consecutive operation duration according to a time threshold and the average response time of each of the unit times in each of the operation durations. Here, the unit time is greater than zero and less than the operation duration.

In one embodiment, a method for dynamically adjusting power configuration comprises receiving at least one transaction data; executing batch updates of financial data stored in a storage unit according to the transaction data under a power supply mode; counting a response time of each of the batch updates; calculating an average response time of each of unit times in each of a plurality of operation durations according to the responses times of all of the batch updates in each of the unit times; and configuring the power supply mode in at least one consecutive operation duration according to a time threshold and the average response time in each of the operation durations. Wherein, the unit time is greater than zero and less than the operation duration.

As above, the method for dynamically updating financial data, the processing system using the same, the method for dynamically adjusting power configuration, and the processing system using the same, in accordance with one of the forgoing embodiments can dynamically adjust the batch size or the power configuration or other system parameters according to external environmental dynamic factors (like network, hardware performance, etc.). Therefore, the processing system can have a better data processing state, so that the occurrence frequency of the transaction timeout events can be reduced and the system resources can be utilized efficiently.

### BRIEF DESCRIPTION OF THE DRAWINGS

The disclosure will become more fully understood from the detailed description given herein below for illustration only, and thus not limitative of the disclosure, wherein:

FIG. 1 illustrates a functional block diagram of a processing system for financial data of one embodiment of the instant disclosure;

FIG. 2 illustrates a flowchart of a method for dynamically updating financial data of one embodiment of the instant disclosure;

FIG. 3 illustrates a flowchart of one example embodiment of the step S37 shown in FIG. 2;

FIG. 4 illustrates a partial flowchart of a method for dynamically updating financial data of another embodiment of the instant disclosure;

FIG. 5 illustrates a flowchart of a method for dynamically updating financial data of yet another embodiment of the instant disclosure;

FIG. 6 illustrates a flowchart of one example embodiment of the step S37′ shown in FIG. 5;

FIG. 7 illustrates a flowchart of a method for dynamically adjusting power configuration of one embodiment of the instant disclosure; and

FIG. 8 illustrates a flowchart of one example embodiment of the step S70 shown in FIG. 7.

### DETAILED DESCRIPTION

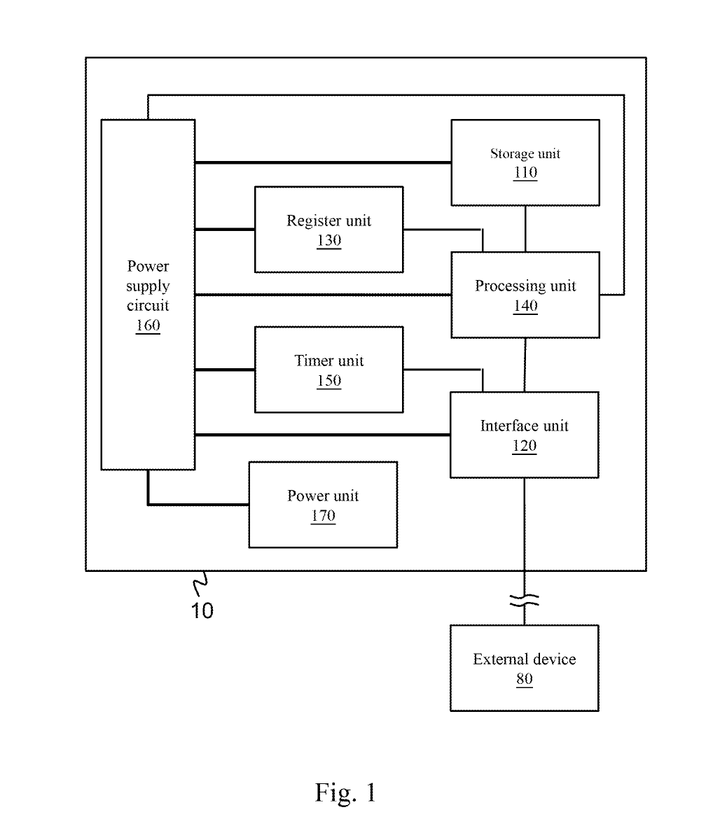

FIG. 1 illustrates a functional block diagram of a processing system for financial data of one embodiment of the instant disclosure. Please refer to FIG. 1. The processing system for financial data (hereinafter, simply called “processing system 10”) can conduct a dynamic updating for financial data based on the system resources. The processing system 10 comprises a storage unit 110, an interface unit 120, a register unit 130, a processing unit 140, and a timer unit 150. The processing unit 140 is connected to the storage unit 110, the interface unit 120, the register unit 130, and the timer unit 150.

The storage unit 110 stores many identification data and financial data of each of the identification data. In other words, the storage unit 110 stores many financial data, and each of the financial data is related to one corresponding identification data. For example, a relational database is installed in the storage unit 110, and the relational database records related information of many financial accounts. Wherein, the related information of each of financial accounts at least comprises identification data and financial data.

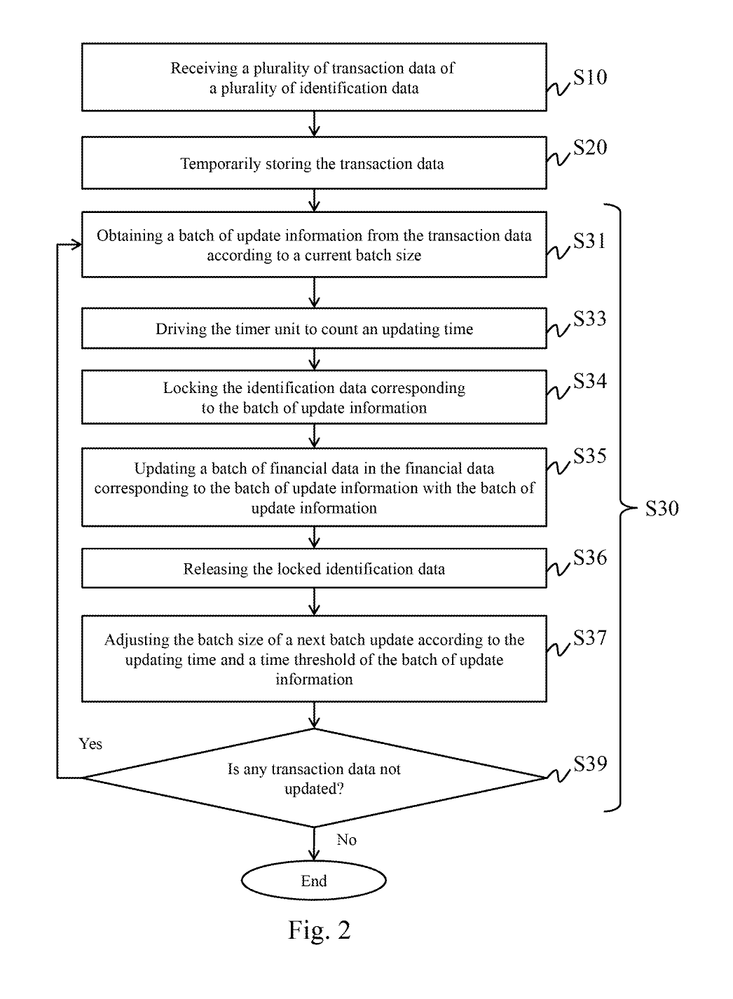

FIG. 2 illustrates a flowchart of a method for dynamically updating financial data of one embodiment of the instant disclosure. Please refer to FIGS. 1 and 2. In some embodiments, the interface unit 120 receives transaction data of many identification data (step S10). In this embodiment, the interface unit 120 is an interface for exterior, and the interface unit 120 may receive transaction data from an external device 80 wiredly or wirelessly.

In some embodiments, the transaction data may comprise, but not limited to, at least one of name, birthday, ID number, mobile number, login account, login password, electronic certificate, PKI key, account number, debit card number, credit card number, valuable card number, and prepaid card number. The financial data may be, but not limited to, at least one of expiry year and month and/or numbers on the back of the card, card verification number, default password, credit amount, deposit amount, payout amount, transfer amount, consumption amount, account balance, due date, payment type. For example, in the case that the identification data is the account number, the financial data may be the account balance, and the transaction data may be the payout amount. On the other hand, in the case that the identification data is the credit card number, the financial data may be the credit amount, and the transaction data may be the transaction amount.

The processing unit 140 receives the transaction data through the interface unit 120, and the processing unit 140 temporarily stores the transaction data in the register unit 130 (step S20).

Then, the processing unit 140 executes batch updates of the financial data of the same identification data according to a batch size and the transaction data (step S30). In other words, the processing unit 140 updates the financial data of the same identification data by N times of batch updates according to a batch size and the received transaction data. Wherein, N is a positive integer.

In some embodiments of the step S30, in executing each of the batch updates, the processing unit 140 obtains a batch of update information from the transaction data according to a current batch size (step S31). In other words, the processing unit 140 obtains a number of transaction data from the transaction data stored in the register unit 130 as a batch of update information, and the number of the transaction data is the current batch size.

When the batch of update information begins to update, the processing unit 140 drives the timer unit 150 to count an updating time (step S33) and updates a batch of financial data in the financial data corresponding to the batch of update information with the batch of update information (step S35). In other words, the processing unit 140 controls the timer unit 150 to count the consumed time duration from the beginning of the updating to the completion of the updating of the batch of update information (i.e., the updating time).

For example, regarding one example embodiment of step S33, in the case that the financial data is the account balance and the transaction data is the payout amount, the processing unit 140 subtracts the payout amount from the account balance of the same identification data to obtain a new account balance. When the new account balance is a positive number, the processing unit 140 stores the new account balance back to the storage unit 110. That is, the account balance of the same identification data originally stored in the storage unit 110 is replaced by the new account balance. When the new account balance is a negative number, the processing unit 140 retains the account balance of the same identification data originally stored in the storage unit 110 and sends a refusal-to-transact signal of the transaction (i.e., the payout amount of the identification data) via the interface unit 120. Regarding another example embodiment of step S33, in the case that the financial data is the credit amount and the transaction data is the transaction amount, the processing unit 140 subtracts the transaction amount from the credit amount to obtain a new credit amount (i.e., remaining credit amount). When the new credit amount is a positive number, the processing unit 140 stores the new credit amount back to the storage unit 110. That is, the credit amount of the same identification data originally stored in the storage unit 110 is replaced by the new credit amount. When the new credit amount is a negative number, the processing unit 140 retains the credit amount of the same identification data originally stored in the storage unit 110 and sends a refusal-to-transact signal of the transaction (i.e., the transaction amount of the identification data) via the interface unit 120.

When the updating of the batch of update information is completed, the processing unit 140 adjusts the batch size of a next batch update according to the updating time and a time threshold (hereinafter, called first time threshold) of the batch of update information (step S37). Next, the processing unit 140 confirms whether the register unit 130 has transaction data that are not updated (step S39). If the register unit 130 has transaction data that are not updated, the processing unit 140 obtains the next batch of update information according to a new batch size (step S31) and executes the subsequent steps. Conversely, if the register unit 130 does not have transaction data that are not updated, the processing unit 140 completes the batch update of the financial data. In some embodiments, every time the processing unit 140 obtains the update information, the processing unit 140 records the retrieving location (the register unit 130 or the storage unit 110) of the update information. On the other hand, every time the processing unit 140 obtains the update information, the processing unit 140 tags the transaction data that is regarded as the batch of update information in the register unit 130.

For example, when the number of the received transaction data is 10,000 and the current batch size is 500, the processing unit 140 retrieves the 1^{st} transaction data to the 500^{th} transaction data from the received transaction data as a batch of update information (a first batch of update information), and executes an updating of financial data corresponding to the batch of update information with the batch of update information. When the updating of the batch of update information is completed, the processing unit 140 adjusts the batch size according to the current processing state of the updating (i.e., the updating time and the first time threshold). If the processing unit 140 adjusts the batch size to 750 according to the current processing state of the updating, the processing unit 140 retrieves the 501^{st} transaction data to the 1250^{th} transaction data from the received transaction data as a batch of update information (a second batch of update information), and executes an updating of financial data corresponding to the batch of update information with the batch of update information. When the updating of the batch of update information is completed, the processing unit 140 adjusts the batch size according to the current processing state of the updating (i.e., the updating time and the first time threshold). So on and so forth, until all of the transaction data have been retrieved (i.e., all of the transaction data have undergone the updating).

In some embodiments, before updating the batch of update information (step S35), the processing unit 140 can lock the identification data corresponding to the batch of update information in advance, namely, the processing unit 140 can restrict the transaction events of the identification data (step S34). In addition, during updating the financial data corresponding to the batch of update information with the batch of update information, the corresponding identification data are retained in a locked state. Next, after the updating of the financial data corresponding to the batch of update information with the batch of update information is completed, the processing unit 140 releases the locked identification data (step S36). In other words, in the case that the identification data is in the locked state, when the processing unit 140 receives transaction data of the locked identification data from other external device (hereinafter called additional transaction data), the processing unit 140 does not execute the updating of the corresponding financial data according to the additional transaction data. In other words, the processing unit 140 refuses the transaction of the additional transaction data.

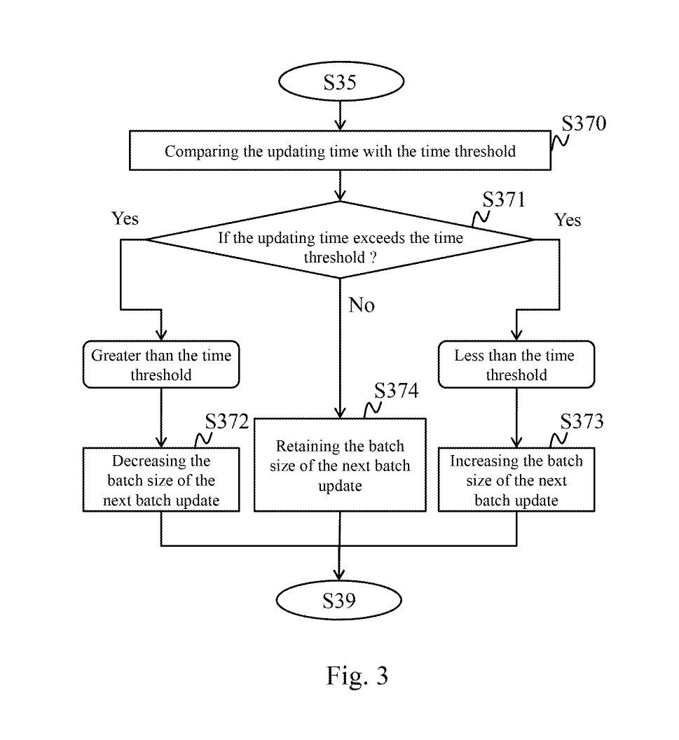

FIG. 3 illustrates a flowchart of one example embodiment of the step S37 shown in FIG. 2. Please refer to FIGS. 1 to 3. In some embodiments of the step S37, after the updating of the batch of update information is completed, the processing unit 140 compares the updating time consumed by the batch of update information with the first time threshold (step S370) to determine if the updating time exceeds the first time threshold (step S371). When the updating time is greater than the first time threshold (i.e., the updating time exceeds lower limit of the first time threshold, that represents the batch of update information still have data that are not updated when the updating has lasted for the first time threshold), the processing unit 140 decreases the batch size of the next batch update (step S372). When the updating time is less than the first time threshold (i.e., the updating time exceeds the first time threshold, that represents the batch of update information is already updated before the updating lasted for the first time threshold), the processing unit 140 increases the batch size of the next batch update (step S373). Conversely, when the updating time does not exceed the first time threshold, the processing unit 140 may retain the batch size of the next batch update (step S374).

In some embodiments, the first time threshold may be a predetermined value (a single value), e.g., 0.5 seconds. Here, the updating time exceeds the first time threshold means that the updating time is greater than the first time threshold or less than the predetermined value; conversely, the updating time does not exceed the first time threshold means that the updating time is equal to the predetermined value. In some other embodiments, the first time threshold may be a range between an upper limit value and a lower limit value, e.g., 0.4 to 0.6 seconds. Here, the updating time exceeds the first time threshold means that the updating time is greater than the upper limit value or less than the lower limit value; conversely, the updating time does not exceed the first time threshold means that the updating time is less than or equal to the upper limit value and the updating time is greater than or equal to the lower limit value.

In some embodiments, an increase range of the batch size may be equal to the decrease range of the batch size. In other some embodiments, the increase range of the batch size may be less than the decrease range of the batch size. In other words, the decreased value in the next batch update is greater than the increased value in the next batch update. Accordingly, when the processing system 10 is busy (i.e., when the updating time is greater than the first time threshold), the updating size (the batch size) can be decreased rapidly. Therefore, the resources consumed by the processing system 10 can be reduced and the time for locking the identification data can be reduced. Hence, the user of the identification data can perform transactions smoothly. On the other hand, when the processing system 10 is free (i.e., when the updating time is less than the first time threshold), the updating size (the batch size) can be increased slightly. Therefore, the processing system 10 can be prevented from being busy instantly and transaction of the user of the identification data can be prevented from being performed unsmoothly. For example, the decrease range of the batch size of the next batch update may be 50% of the current batch size; that is, the batch size of the next batch update may be 50% of the current batch size. Conversely, the increase range of the batch size of the next batch update may be 25% of the current batch size; that is, the batch size of the next batch update may be 125% of the current batch size. In some embodiments, the batch size may be a positive integer. When the adjustment amount of the batch size calculated by the processing unit 140 is not an integer, the processing unit 140 can take an integer closest to and greater than the adjustment amount to adjust the batch size (to decrease the batch size or to increase the batch size). In some other embodiments, when the adjustment amount of the batch size calculated by the processing unit 140 is not an integer, the processing unit 140 can take an integer closest to and greater than the adjustment amount to decrease the batch size and take an integer closest to and less than the adjustment amount to increase the batch size. For example, supposed that the current batch size is 25 and the decrease range is 50% of the current batch size, when the processing unit 140 tends to decrease the batch size, the processing unit 140 firstly calculates that the adjustment amount of the batch size is 12.5, and then the processing unit 140 decreases the batch size by the adjustment amount of 13 to obtain a batch size of 12 (i.e., the batch size of the next batch update is 12).

In some embodiments, the first time threshold may be set in advance according to a required ideal response time and stored in the storage unit 110.

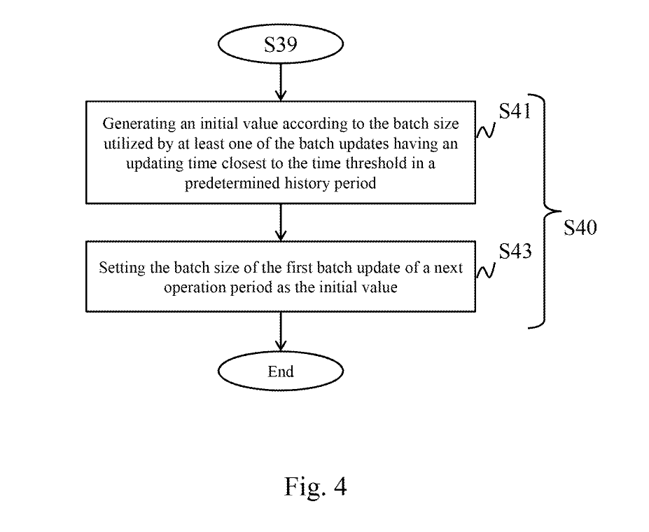

FIG. 4 illustrates a partial flowchart of a method for dynamically updating financial data of another embodiment of the instant disclosure. In some embodiments, please refer to FIG. 4, the processing unit 140 sets an initial batch size of a next operation period according to the history record of batch updates (i.e., the batch size and the updating time of each of the batch updates) (step S40). In other words, every time the batch update is completed, the processing unit 140 records the batch size utilized in the batch update and the updating time in the storage unit 110 to form the history record of the batch updates. Namely, the history record of the batch updates comprises the batch size and the updating time utilized by each of the completed batch updates. In some embodiments, the processing unit 140 can generate an initial value according to the batch size utilized by at least one of the batch updates having an updating time closest to the first time threshold in a predetermined history period (step S41) and sets the batch size (the initial batch size) of the first batch update (the initial batch update) of a next operation period as the initial value (step S43). Wherein, the predetermined history period can be one or several days. For example, when the predetermined history period is one day, the processing unit 140 sets the initial batch size of the next operation period according to the history record of all of the batch updates in the event day (24 hours before the next operation period). Furthermore, the predetermined history period also may be a certain time duration in the predetermined days. The predetermined days may be one day (e.g., the same day), two days (e.g., the event day and the day before the event day), three days, or more. The specific time duration may be the transaction peak duration (e.g., from 23:00 of the same day to 03:00 of the next day; i.e., from 00:00 to 03:00 and from 23:00 to 00:00), the dining time (e.g., from 07:00 to 09:00, from 11:30 to 14:00, or from 19:00 to 22:00). Wherein, each of the operation periods may be 24 hours, 48 hours, or one week, etc. Furthermore, the switching point of the operation period may be anytime. For example, when the operation period is 24 hours, the switching point of the operation period may be 00:00, 16:00, or anytime.

For example, the history record of all of the batch updates in the event day is shown as Table 1 below. Please refer to Table 1. When that the first time threshold is 500 ms, the processing unit 140 takes 2500 as an initial batch size of the next day.

TABLE 1

| Batch updates | Batch size (number) | Updating time (ms) |
|---|---|---|
| 1 | 6,400 | 1000 |
| 2 | 3,200 | 700 |
| 3 | 1,600 | 550 |
| 4 | 800 | 450 |
| 5 | 1,000 | 450 |
| 6 | 1,250 | 400 |
| 7 | 16,00 | 400 |
| 8 | 2,000 | 450 |
| 9 | 2,500 | 500 |
| 10 | 2,500 | 480 |
| 11 | 3,125 | 470 |

Please refer to FIG. 1. The processing system 10 may further comprise a power supply circuit 160 and a power unit 170. The power unit 170 is connected to the power supply circuit 160. The power supply circuit 160 is connected to the components (the storage unit 110, the interface unit 120, the register unit 130, the processing unit 140, and the timer unit 150, etc.) of the processing system 10. The power unit 170 is adapted to supply a power source. The power supply circuit 160 has several power supply modes, and the power supply modes comprise a high performance mode and a low performance mode. The power supply circuit 160 is controlled by the processing unit 140 to supply electricity for operating the processing system 10 according to one of the power supply modes.

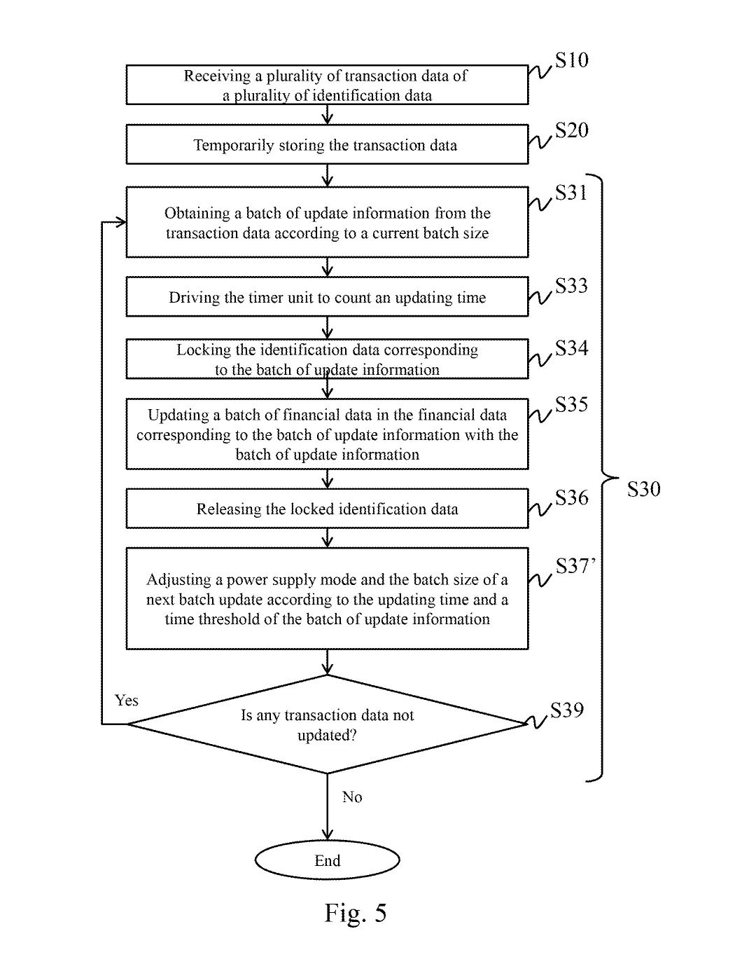

FIG. 5 illustrates a flowchart of a method for dynamically updating financial data of yet another embodiment of the instant disclosure. Please refer to FIGS. 1, 4, and 5, after the updating of the batch of update information is completed, the processing unit 140 may optionally adjust the batch size of a next day or the processing unit 140 may further configure the power supply mode according to the updating time of the batch of update information and the first time threshold (step S37′).

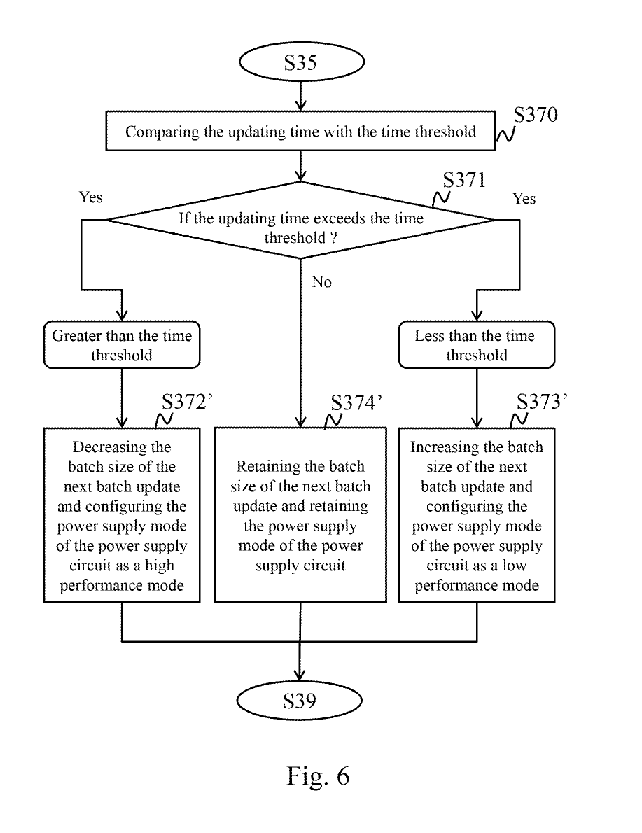

FIG. 6 illustrates a flowchart of one example embodiment of the step S37′ shown in FIG. 5. Please refer to FIG. 6, in one embodiment of the step S37′, after the updating of the batch of update information is completed, the processing unit 140 compares the updating time consumed by the batch of update information with the first time threshold (step S370) to determine if the updating time exceeds the first time threshold (step S371). When the updating time exceeds the first time threshold and when the updating time is greater than the first time threshold (i.e., the batch of update information still has data that are not updated when the updating has lasted for the first time threshold), the processing unit 140 decreases the batch size of the next batch update and configures the power supply mode of the power supply circuit 160 as the high performance mode (step S372′). When the updating time exceeds the first time threshold and when the updating time is less than the first time threshold (i.e., the batch of update information is already updated before the updating lasted for the first time threshold), the processing unit 140 increases the batch size of the next batch update and configures the power supply mode of the power supply circuit 160 as the low performance mode (step S373′). Conversely, when the updating time does not exceed the first time threshold, the processing unit 140 may retain the batch size of the next batch update and retain the power supply mode of the power supply circuit 160 (step S374′).

For example, in the case that the identification data is the credit card number, the financial data is the account detail, and the transaction data is the consumption information, the storage unit 110 in the processing system 10 stores many credit card numbers and account details (e.g., the account detail may be consumption amount, currency, consumption date, invoice date, invoice unit, total credit amount, remaining credit amount, closing date, and authentication number). The first time threshold may be preset as 0.5 seconds. When the interface unit 120 receives an X number of consumption information (e.g., the consumption information may be credit card number, consumption amount, consumption date, and invoice unit), the processing unit 140 temporarily stores the X number of consumption information in the register unit 130. Next, the processing unit 140 begins to execute batch updates. In the first batch update, the processing unit 140 retrieves a k number of consumption information from the register unit 130 as a first batch of update information according to a preset initial batch size (in this embodiment, the initial batch size is k) and locks the credit card number corresponding to the consumption information. Then, the processing unit 140 drives the timer unit 150 to count the updating time and updates the account detail of the same credit card number stored in the storage unit 110 with the first batch of update information, one by one. Regarding the updating of one update information, based on the credit card number of the consumption information (the update information), the processing unit 140 finds the account detail of the same credit card number and checks if the remaining credit amount in the account detail is enough to afford the consumption amount in the consumption information. When the consumption amount is less than or equal to the remaining credit amount, the processing unit 140 adds basic information like credit card number, consumption amount, consumption date, invoice unit to the account detail and subtracts the consumption amount from the remaining credit amount originally recorded in the account detail to generate a new remaining credit amount (that is, the remaining credit amount recorded in the account detail is updated with the new remaining credit amount). After the updating of all of the consumption information in the first batch of update information is completed, the processing unit 140 controls the timer unit 150 to stop counting to obtain the updating time consumed by the first batch of update information and to determine if the batch size needs to be adjusted. In other words, when the updating time of the i-th batch of update information is less than 0.5 seconds, the processing unit 140 increases the batch size of the i+1-th batch of update information. Conversely, when the updating time of the i-th batch of update information is greater than 0.5 seconds, the processing unit 140 decreases the size of the i+1-th batch of update information. Wherein, the processing unit 140 can zero the timer unit 150 after the updating time is read out or before the updating of the next batch of updating data. Here, X is a positive integer, k is a positive integer less than k, and i is a positive integer less than X.

In addition, when the updating time of the i-th batch of update information is greater than 0.5 seconds, the processing unit 140 further generates a high performance signal to the power supply circuit 160. Next, the power supply circuit 160 increases the output efficiency in response to the high performance signal (that is, the power supply mode of the power supply circuit 160 is switched to the high performance mode). On the other hand, when the updating time of the i-th batch of update information is less than 0.5 seconds, the processing unit 140 further generates a low performance signal to the power supply circuit 160. Next, the power supply circuit 160 decreases the output efficiency in response to the low performance signal (that is, the power supply mode of the power supply circuit 160 is switched to the low performance mode).

Here, each of the operation periods of the processing unit 140 may be 24 hours. After the completion of the t-th operation period (i.e., at the beginning of the t+1-th operation period), the processing unit 140 can obtain the batch size utilized by a batch update having an updating time closest to 0.5 seconds from the history record of all of the batch updates in the t-th operation period, and the processing unit 140 can take the obtained batch size as the batch size (initial batch size) of a first batch update in the t+1-th operation period. On the other hand, the processing unit 140 can find the batch sizes utilized by ten batch updates having updating times closest to 0.5 seconds from the history record of all of the batch updates in the t-th operation period, and the processing unit can calculated an average batch size of the ten batch updates and take the average batch size as the batch size (initial batch size) of a first batch update in the t+1-th operation period.

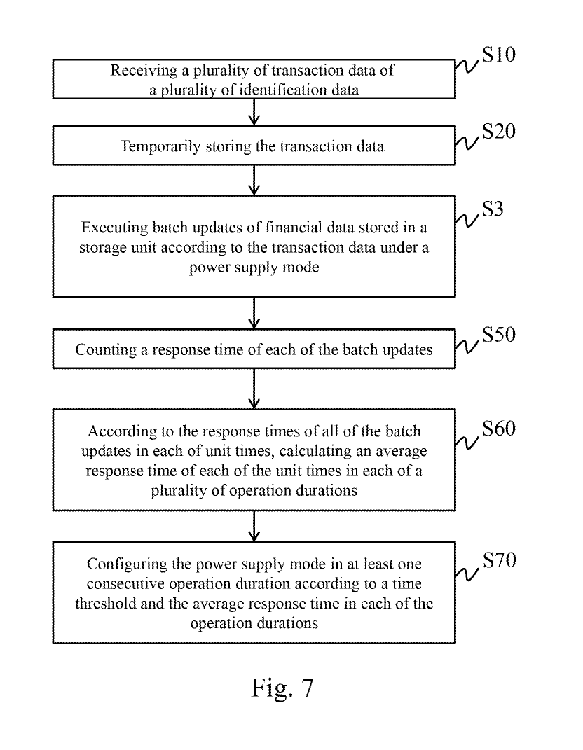

In some embodiment, the processing system for financial data (hereinafter, simply called “processing system 10”) can further execute a dynamic adjustment for power configuration according based on the system resources. FIG. 7 illustrates a flowchart of a method for dynamically adjusting power configuration of one embodiment of the instant disclosure. Please refer to FIGS. 1 and 7, in some embodiments, the interface unit 120 receives a plurality of financial data (step S10), and the processing unit 140 receives transaction data via the interface unit 120 and temporarily stores the transaction data in the register unit 130 (step S20). Next, the processing unit 140 executes batch updates of the financial data stored in the storage unit 110 according to the transaction data under a power supply mode (i.e., the power supply circuit 160 supplies electricity based on the power supply mode) (step S3). In some embodiments of the step S3, the execution of the batch updates of the financial data may be the same as that in the step S30, as mentioned.

In addition, the processing unit 140 controls the timer unit 150 to count a response time of each of the batch updates (step S50). Wherein, the unit time is greater than zero.

Here, the processing unit 140 calculates an average response time of each of the unit times in each of the operation durations according to the response times of all of the batch updates in each of the unit times (step S60). Wherein, the time duration is less than the operation duration and is several times of the unit time.

Next, the processing unit 140 configures the power supply mode of the power supply circuit in at least one consecutive operation duration (e.g., a next operation duration or next two operation durations) according to a time threshold (hereinafter, called second time threshold) and the average response time of each of the unit times in each of the operation durations (step S70).

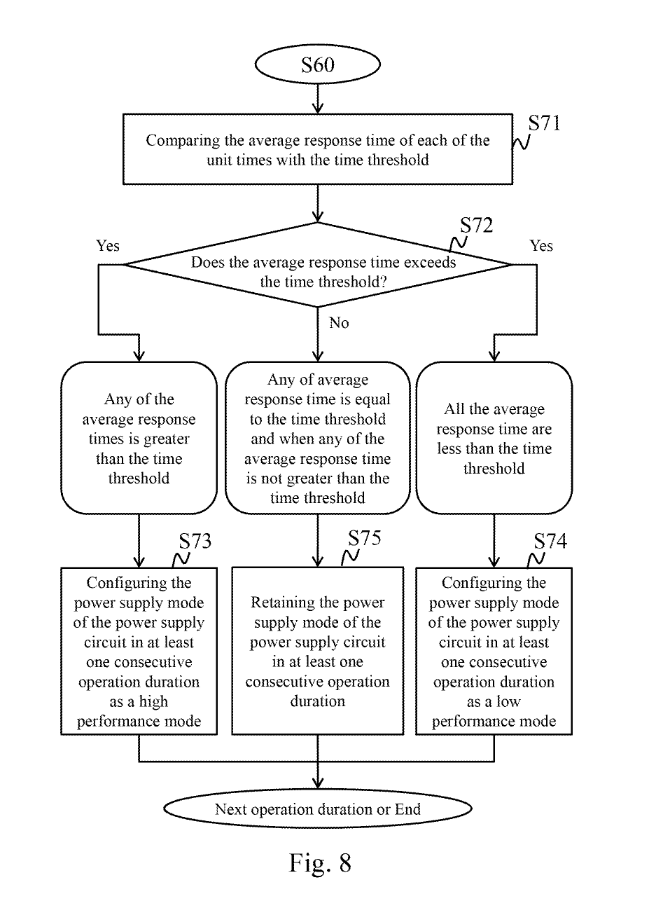

FIG. 8 illustrates a flowchart of one example embodiment of the step S70 shown in FIG. 7. Please refer to FIGS. 1, 7, and 8, in some embodiments of the step S70, in any of the operation durations, the processing unit 140 compares the average response time of each of the time durations with the second time threshold (step S71) and checks if the average response time exceeds the second time threshold (step S72). When the average response time of any of the time durations is greater than the second time threshold (i.e., when the average response time exceeds the second time threshold), the processing unit 140 configures the power supply mode of the power supply circuit in at least one consecutive operation duration as a high performance mode (step S73). When the average response times of all of the time durations are less than the second time threshold (i.e., when all of the average response times exceeds the second time threshold), the processing unit 140 configures the power supply mode of the power supply circuit 160 in the at least one consecutive operation duration as a low performance mode (step S74). Conversely, when the average response time of any of the time durations equals to the second time threshold and when the average response time of any of the time durations is not greater than the second time threshold (when the average response time of any of the time durations does not exceed the second time threshold), the processing unit 140 may retain the power supply mode of the power supply circuit 160 in the at least one consecutive operation period (step S75). In some embodiments, the number of the operation durations configured in the high performance mode may be equal to that of the operation durations configured in the low performance mode. However, it is understood that, the number of the operation durations configured in the high performance mode may be different from that of the operation durations configured in the lower performance mode. For example, when the average response time of any of the time durations is greater than the second time threshold, the processing unit 140 configures the power supply mode of the power supply circuit 160 as the high performance mode in consecutive two operation durations. On the other hand, when the average response times of all the time durations are less than the second time threshold, the processing unit 140 configures the power supply mode of the power supply circuit 160 as the low performance mode in consecutive one operation duration. In some embodiments, after the power supply mode of the next operation mode is configured, the processing unit does not adjust the power supply mode of the next operation mode no matter the comparison result of the current operation duration (step S72). That is, the configurations in the step S73 and the step S74 are forcible configurations.

In some embodiments, the second time threshold may be a predetermined value (a single value), e.g., 0.5 seconds. In some other embodiments, the first time threshold may be a range between an upper limit value and a lower limit value, e.g., 0.4 to 0.6 seconds. Here, being greater than the second time threshold means that being greater than the upper limit value, being less than the second time threshold means that being less than the lower limit value, and being equal to the second time threshold means that being less than or equal to the upper limit value and greater than or equal to the lower limit value. Here, the second time threshold may be equal to the first time threshold or may be different from the first time threshold.

For example, when each of the operation durations is half hour and the unit time is one minute, regarding the time 18:00 as an example, the processing unit calculates an average value (i.e., the average response time) of the response time of all the batch updates executed in every minute during 18:00 to 18:30, and the processing unit compares the calculated average response time of every minute during 18:00 to 18:30 with the second time threshold (e.g., 0.5 seconds). When the average response time of any minute during 18:00 to 18:30 is greater than 0.5 seconds, the processing unit configures the power supply mode of the power supply circuit as the high performance mode in the time duration from 18:30 to 19:00 or configures the power supply mode of the power supply circuit as the low performance mode in the time duration from 18:30 to 19:30. When the average response time of every minute during 18:00 to 18:30 is less than 0.5 seconds, the processing unit configures the power supply mode of the power supply circuit as the low performance mode in the time duration from 18:30 to 19:00, or configures the power supply mode of the power supply circuit as the low performance mode in the time duration from 18:30 to 19:30.

In some embodiments, the processing unit may further forcibly configure the power supply mode of the power supply circuit as the high performance mode in a certain time duration. In other words, the power supply mode of the power supply circuit does not change because of the comparison result (step S72). Wherein, the certain time duration may be the transaction peak duration (e.g., from 23:00 of the same day to 03:00 of the next day; i.e., from 00:00 to 03:00 and from 23:00 to 00:00), the dining time (e.g., from 07:00 to 09:00, from 11:30 to 14:00, or from 19:00 to 22:00).

It is understood that, the order of the steps described in the above is provided for illustrative purpose, not a limitation. It is understood that some the steps may be performed at the same time, or may be exchanged with each other.

In some embodiments, the processing unit 140 may be implemented by one or several processing components. Here, the processing component may be, but not limited to, a microprocessor, a microcontroller, a digital signal processor, a microcomputer, a central processor, a field programmable gate array, a programmable logic device, a state machine, a logic circuit, an analog circuit, a digital circuit, and/or any equipment based on (analog and/or digital) control command.

In some embodiments, the storage unit 110 may be implemented by one or several storage components. Here, the storage unit may be different kinds of memories or registers, but embodiments are not limited thereto. In some embodiments, the register unit 130 may be, but not limited to, implemented by one or several registers.

In some embodiments, the interface unit 120 may be a connection port or a network module of a peripheral device. Wherein, the connection port may be conformed to universal serial bus (USB) standard, parallel advanced technology attachment (PATA) standard, Institute of electrical and electronic engineers (IEEE) 1394 standard, peripheral component interconnect express (PCI express) standard, serial advanced technology attachment (SATA) standard, ultra high speed-I (UHS-I) interface standard, ultra high speed-II (UHS-II) interface standard, secure digital (SD) interface standard, memory stick (MS) interface standard, multimedia card (MMC) interface standard, compact flash (CF) interface standard, integrated device electronics (IDE) standard or other proper standard connection ports. Furthermore, the network module may be capable of performing wireless transmission and/or wiredly transmission. For example, the network module may be, but not limited to, a Wi-Fi module, a Bluetooth module, an Ethernet network module.

In some embodiments, the aforementioned external device 80 may be a remote host or a card reader, etc. Wherein, the remote host may be server, any computer, mobile phone, smart appliance, etc.

In some embodiments, the aforementioned power unit 170 may be a battery module for storing the power source or may be a power input interface (e.g., a receptacle for electricity wire) for receiving the external power to be served as the power source.

In some embodiments, the low performance mode may be a balanced mode or a power saver mode.

As above, the method for dynamically updating financial data, the processing system using the same, the method for dynamically adjusting power configuration, and the processing system using the same, in accordance with one of the forgoing embodiments can dynamically adjust the batch size or the power configuration or other system parameters according to external environmental dynamic factors (like network, hardware performance, etc.). Therefore, the processing system can have a better data processing state, so that the occurrence frequency of the transaction timeout events can be reduced and the system resources can be utilized efficiently. Alternatively, proper initial parameters can be set based on the history record, so that the processing system can be in a better state before executing the data computation and before executing the updating.

What is claimed is:

1. A processing system for dynamically updating financial data, comprising:
a storage unit storing a plurality of identification data and a plurality of financial data of the identification data;
a timer unit counting an updating time;
an interface unit receiving a plurality of transaction data of the identification data;
a register unit temporarily storing the transaction data; and
a processing unit connected to the storage unit, the timer unit, the interface unit, and the register unit, wherein the processing unit executes batch updates of the financial data of the same identification data according to a batch size and the transaction data;
wherein, in executing each of the batch updates, the processing unit obtains a batch of update information from the transaction data according to a current batch size, drives the timer unit, updates a batch of financial data, corresponding to the batch of update information, in the financial data with the batch of update information, and adjusts the batch size of a next batch update according to the updating time and a time threshold of the batch of update information.

2. The processing system for dynamically updating financial data according to claim 1, wherein when a length of the updating time is less than the time threshold, the processing unit increases the batch size of the next batch update, and wherein when the length of the updating time is greater than the time threshold, the processing unit decreases the batch size of the next batch update.

3. The processing system for dynamically updating financial data according to claim 2, wherein an increase range of the batch size is greater than a decrease range of the batch size.

4. The processing unit for dynamically updating financial data according to claim 1, wherein the processing unit further generates an initial value according to the batch size utilized by at least one of the batch updates having an updating time closest to the time threshold in a predetermined history period, and sets the batch size of an initial batch update of a next operation period as the initial value.

5. The processing unit for dynamically updating financial data according to claim 1, further comprising:
a power unit, storing a power source; and
a power supply circuit connected to the storage unit, the timer unit, the interface unit, the register unit, the processing unit, and the power unit, wherein the power supply circuit is controlled by the processing unit, and the power supply circuit supplies electricity, based on the power unit, for operating the interface unit, the storage unit, the timer unit, and the processing unit;
wherein, in each of the batch updates, the processing unit further configures a power supply mode of the power supply circuit according to the updating time and the time threshold of the batch of update information.

6. The processing system for dynamically updating financial data according to claim 5, wherein when the updating time is greater than the time threshold, the processing unit configures the power supply mode of the power supply circuit as a high performance mode, and wherein when the updating time is less than the time threshold, the processing unit configures the power supply mode of the power supply circuit as a low performance mode.

7. The processing system for dynamically updating financial data according to claim 1, wherein the interface unit is a connection port or a network module of a peripheral device.

8. The processing system for dynamically updating financial data according to claim 1, wherein in the process of updating the batch of financial data in the financial data corresponding to the batch of update information with the batch of update information, the processing unit locks the identification data corresponding to the batch of update information.

9. A method for dynamically updating financial data, suitable for updating a plurality of financial data of a plurality of identification data, the method comprising:
receiving a plurality of transaction data of the identification data;
temporarily storing the transaction data; and
executing batch updates of the financial data of the same identification data according to a batch size and the transaction data, wherein the step of executing each of the batch updates comprises:
obtaining a batch of update information from the transaction data according to a current batch size;
driving a timer unit to count an updating time;
updating a batch of financial data in the financial data corresponding to the batch of update information with the batch of update information; and
adjusting the batch size of a next batch update according to the updating time and a time threshold of the batch of update information.

10. The method for dynamically updating financial data according to claim 9, wherein the adjusting step comprises:
increasing the batch size of the next batch update when the updating time is less than the time threshold; and
decreasing the batch size of the next batch update when the updating time is greater than the time threshold.

11. The method for dynamically updating financial data according to claim 10, wherein an increase range of the batch size is greater than a decrease range of the batch size.

12. The method for dynamically updating financial data according to claim 9, further comprising:
generating an initial value according to the batch size utilized by at least one of the batch updates having an updating time closest to the time threshold in a predetermined history period and sets the batch size of an initial batch update of a next operation period as the initial value.

13. The method for dynamically updating financial data according to claim 9, wherein the step of executing each of the batch updates further comprises:
configuring a power supply mode according to the updating time and the time threshold of the batch of update information.

14. The method for dynamically updating financial data according to claim 13, wherein when the updating time is greater than the time threshold, configuring the power supply mode as a high performance mode, and wherein when the updating time is less than the time threshold, configuring the power supply mode as a low performance mode.

15. The method for dynamically updating financial data according to claim 9, wherein the receiving step comprises receiving the transaction data of the identification data through a connection port of a peripheral device or a network.

16. The method for dynamically updating financial data according to claim 9, wherein the step of executing each of the batch updates further comprises:
in the process of updating the batch of financial data in the financial data corresponding to the batch of update information with the batch of update information, locking the identification data corresponding to the batch of update information.

17. A processing system for dynamically adjusting power configuration, comprising:
an interface unit receiving at least one transaction data;
a storage unit storing a plurality of financial data;
a timer unit counting a response time for each of batch updates;
a power unit supplying a power source;
a processing unit connected to the interface unit, the storage unit, the timer unit, and the power unit, wherein the processing unit executes at least one time of the batch update of the financial data according to the transaction data; and
a power supply circuit connected to the interface unit, the storage unit, the timer unit, the power unit, and the processing unit, wherein the power supply circuit is controlled by the processing unit, and the power supply circuit supplies electricity, based on the power unit, for operating the processing unit;
wherein, the processing unit further calculates, according to the response times of all of the batch updates in each of unit times, an average response time of each of the unit times in each of a plurality of operation durations, and the processing unit configures a power supply mode of the power supply circuit in at least one consecutive operation duration according to a time threshold and the average response time of each of the unit times in each of the operation durations, wherein the unit time is greater than zero and less than the operation duration.

18. The processing system for dynamically adjusting power configuration according to claim 17, wherein when all of the average response times in the operation duration are less than the time threshold, the processing unit configures the power supply mode of the power supply unit in the at least one consecutive operation duration as a low performance mode.

19. The processing system for dynamically adjusting power configuration according to claim 18, wherein when any of the average response times in the operation duration is greater than the time threshold, the processing unit configures the power supply mode of the power supply unit in the at least one consecutive operation duration as a high performance mode.

20. The processing system for dynamically adjusting power configuration according to claim 17, wherein when any of the average response times in the operation duration is greater than the time threshold, the processing unit configures the power supply mode of the power supply unit in the at least one consecutive operation duration as a high performance mode.

21. The processing system for dynamically adjusting power configuration according to claim 17, wherein the processing unit forcibly configures the power supply mode of the power supply circuit as a high performance mode in a certain time duration.

22. The processing system for dynamically adjusting power configuration according to claim 17, wherein the interface unit is a connection port or a network module of a peripheral device.

23. A method for dynamically adjusting power configuration, comprising:
receiving at least one transaction data;
executing batch updates of financial data stored in a storage unit according to the transaction data under a power supply mode;
counting a response time of each of the batch updates;
according to the response times of all of the batch updates in each of unit times, calculating an average response time of each of the unit times in each of a plurality of operation durations, wherein the unit time is greater than zero and less than the operation duration; and
configuring the power supply mode in at least one consecutive operation duration according to a time threshold and the average response time in each of the operation durations.

24. The method for dynamically adjusting power configuration according to claim 23, wherein when any of the average response times in the operation durations is greater than the time threshold, the power supply mode in the at least one consecutive operation duration is configured as a high performance mode.

25. The method for dynamically adjusting power configuration according to claim 24, wherein when all of the average response times in the operation duration are less than the time threshold, the power supply mode in the at least one consecutive operation duration is configured as a low performance mode.

26. The method for dynamically adjusting power configuration according to claim 23, wherein when all of the average response times in the operation duration are less than the time threshold, the power supply mode in the at least one consecutive operation duration is configured as a low performance mode.

27. The method for dynamically adjusting power configuration according to claim 23, further comprising:
forcibly configures the power supply mode as a high performance mode in a certain time duration.

28. The method for dynamically adjusting power configuration according to claim 23, wherein the certain time duration is a transaction peak duration.
